(19) United States
(12) Patent Application Publication
(10) Pub. No.: US 2011/0082725 A1
(43) Pub. Date: Apr. 7, 2011

(54) Application Software Video Channel

(76) Inventors: Ryan Steelberg, Irvine, CA (US); Chad Steelberg, Newport Beach, CA (US)

(21) Appl. No.: 12/889,752

(22) Filed: Sep. 24, 2010

Related U.S. Application Data
(60) Provisional application No. 61/278,221, filed on Oct. 2, 2009.
(60) Provisional application No. 61/278,554, filed on Oct. 8, 2009.

(51) Int. Cl. G06Q 30/00; G06F 15/16

(52) U.S. Cl. 705/14.4; 709/219

(57) ABSTRACT

A system and method for selling a software product is described. The system includes a software product resident within the memory of a computer storage device associated with a server that is communicatively connected to a telecommunications network, wherein the software product is suitable for execution on a computing device. Also included is a video program, wherein the video program includes at least one salesperson that promotes the sale of the software product to a customer viewing the video program. After the customer purchases the software product via the telecommunications network, the customer provides identification of the computing device to the server, which distributes the purchased software product via the telecommunications network to the computing device identified by the customer. The method includes providing the service of the above described system.

### CROSS-REFERENCE TO RELATED APPLICATIONS

This application claims priority to U.S. Provisional Application No. 61/278,221, filed Oct. 2, 2009, entitled “Application Software video Channel”, and U.S. Provisional Application No. 61/278,554, filed Oct. 2, 2009, entitled “Application Software video Channel”, the entire disclosures of which are incorporated by reference herein as if each set forth herein in their entirety.

### FIELD OF THE INVENTION

The instant invention relates to a video channel, and in particular to a video channel for advertising, selling and distributing software applications to a computing device.

### BACKGROUND OF THE INVENTION

In the application software industry, methods of advertising, sale and distribution of programs are performed in a very standard and straightforward manner. For example, software programs are sold in boxes at “brick and mortar” retail stores, where the purchaser takes home the boxed product, in which the software is resident on a computer readable memory device, such as a disk, and loads the program onto their computing device from home. Advertising for this sale and distribution model follows standard methods, such as short television or radio clips. In another example, software can be offered and sold via a website, where the product is electronically purchased and distributed from the seller's server directly to the purchaser's computer through, for example, an internet connection. Advertising for this type of sale and distribution typically uses standard Internet advertisements, including hyperlinked ads that send the user to a server for product download.

Unfortunately, the application software industry has not yet been able to leverage the myriad of other advertising, sales and distribution methodologies that exist for other product types. For example, various tangible products can be advertised and sold via “shopping channels”, such as the Home Shopping Network or QVC, which can be seen on cable, satellite, and some terrestrial channels in the United States.

The need for improved marketing avenues of application software is increasing dramatically. For example, the mobile content market, including downloadable games, ringtones, wallpapers, video, mobile TV, text alerts and mobile browsing, is estimated at $67 billion in 2009. Likewise, the US mobile applications market, which stood at approximately $3.8 billion in 2008, is poised to reach the $9 billion mark by 2011. It has been estimated that the mobile content market is larger than the current online advertising market.

Therefore, a need exists for a system and method of implementing improved advertising, sale and distribution of application software products. The present invention meets this need.

### SUMMARY OF THE INVENTION

A system and method for selling a software product is described. The system includes a software product resident within the memory of a computer storage device associated with a server that is communicatively connected to a telecommunications network, wherein the software product is suitable for execution on a computing device. Also included is a video program, wherein the video program includes at least one salesperson that promotes the sale of the software product to a customer viewing the video program. After the customer purchases the software product via the telecommunications network, the customer provides identification of the computing device to the server, which distributes the purchased software product via the telecommunications network to the computing device identified by the customer. The method includes providing the service of the above described system.

### BRIEF DESCRIPTION OF THE FIGURES

Understanding of the present invention will be facilitated by consideration of the following detailed description of the embodiments of the present invention taken in conjunction with the accompanying drawings, in which like numerals refer to like parts and in which:

FIG. 1 illustrates an advertising, sale and distribution system of application software products, according to an aspect of the present invention; and

FIG. 2 illustrates a method of advertising, selling and distributing application software products, according to an aspect of the present invention.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in typical communications systems and software applications. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

The present invention may include systems and methods of using video channels, in part, for the advertising, sale and distribution of application software products.

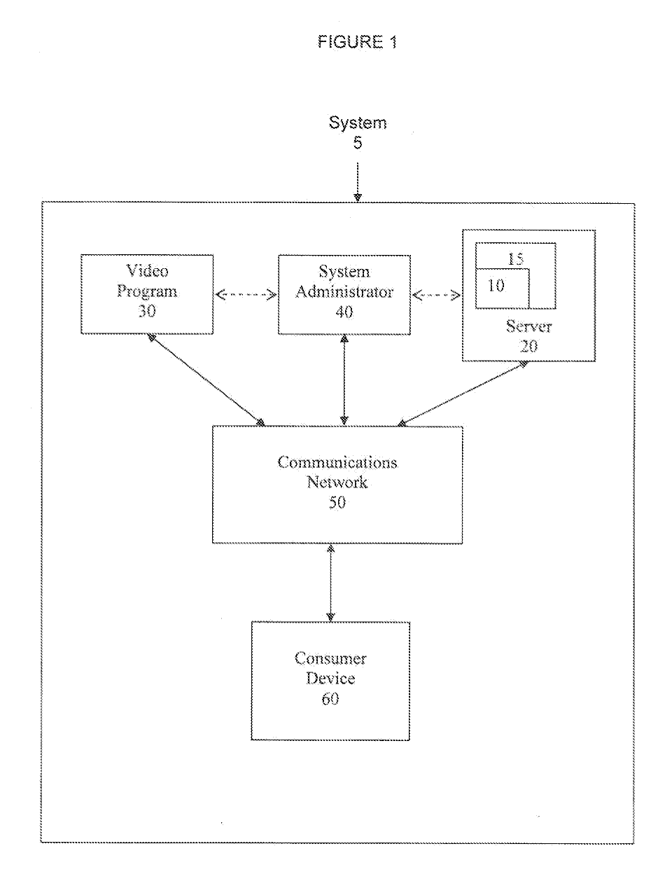

As depicted in FIG. 1, system 5 includes application software products 10, computer memory/storage 15, server 20, video programming 30, a system administrator 40, communications network 50 and one or more consumer computer devices 60.

Application software products 10, as used herein and also referred to herein as “application software”, “software product” or “product”, may include functional software applications using any sort of software programming language and/or formats understood by those skilled in the art. Without limitation, such application software may be generally intended for use with consumer computing devices 60, such as desktop or laptop computers or netbooks, and particularly for handheld computing devices, such as PDAs, phones or any other handheld device. As used herein, a consumer computing device may include any device that is capable of communicatively connecting to communications network 50 and executing the application software product 10. Application software products 10 may be stored on one or more computer readable memory devices 15, which may form part of, or may be separate from, server 20. In either case, server 20 may access for upload or download all application software products 10 to and from memory devices 15. Server 20 may alternatively be a set of servers to provide better and more functionality. It should be appreciated that server 20 and memory device 15 may each be scalable as desired for system 5, and will include all those hardware and programming components necessary for use within system 5. System 5 may include a system administrator 40, for managing and synchronizing video programming 30 with server 20 functionality.

Video programming 30 may be developed, including either live or recorded programming, of one or more salespersons that pitch or recommend software applications available for purchase. Video programming 30 may be provided as a “stand alone” feature, and/or a stand-alone channel, such as an on-demand channel, or it may be incorporated into or integrated with existing content, for example. Salespersons may include program hosts, or special guests, and may further include celebrities, endorsers, or any other person with the ability to draw consumers to the video program and the application software products for sale. Alternatively, animated or virtual salespersons, or a combination of real and virtual salespersons may be used to pitch or recommend the software application products. Video programming 30 may be developed for satellite, cable, broadcast, IP (online video) or any other form of video program distribution as is understood by those skilled in the art. Depending on the distribution format of video programming 30, such programming may also reside on its own computer storage and server system, or it may also be resident within memory device 15 and distributed by server 20.

As contemplated herein, video programming 30 may also include software product 10 demonstrations, or any other type of presentation that allows a consumer to consider purchasing application software product 10. In certain embodiments, such presentations may include an interactive portion, where a consumer may communicate an instruction, a question, or other communication via a networked device that can be answered or responded to by a salesperson, system administrator 40 (which may include any administrative personnel, such as a video program director or staff member), computer server, or alternatively as an interaction or “trial” with the application software 10 for sale. Of course, in the event an interactive feature is used in video programming 30, the video program and consumer must be communicatively connected via communications network 50. Further, video programming 30 may include any sort of marketing and sales format as would be understood by those skilled in the art, for example, such as long and short form direct response marketing.

Video programming 30 may provide a domain name, IP address, or other server 40 identifier so that the consumer can communicate with any interactive portion of the video program, such as menus or overlays accessible via a set top box, either via broadcast or on-demand, and for connection with server 40 so that any purchased software product 10 may be distributed to the consumer's intended device 60. Alternatively, dial-in or voice activated numbers may be provided, to allow the consumer to speak with a system 5 representative to ultimately access application software 10.

Communications network 50 may include any and all forms of telecommunications as understood by those skilled in the art. Examples of such communications may include voice calls, instant messaging, email, streaming data exchange, text messaging, or any other type of communication suitable over a telecommunications network. Multiple networks may form portions of communications network 50, including local networks, wide area networks, and the like.

Consumer devices 60, as mentioned above, may include, without limitation, desktop or laptop computers or netbooks, and particularly handheld computing devices, such as PDAs, phones or any other handheld device, provided such devices are capable of connecting to communications network 50.

In an exemplary embodiment of the preset invention, a consumer may view video programming 30 on a display. Thereafter, the consumer may utilize an interactive computing device, such as device 60 or other network enabled device, such that when that consumer elects to purchase an application software product 10, such as while viewing or pausing the video programming on that device 60, that product can be delivered, or “pushed” to the consumer's device 60 or another elected device indicated by the consumer. For example, the video programming may coincide with metadata for accessing menus or the like, and/or accessing links to execute download, or direct an eventual download, of the requested software to the intended device. Thus, it should be appreciated that delivery to the intended device can be performed regardless of whether the consumer made the purchase directly from the intended device the product, or from a secondary device. The application software product 10 is either queued for delivery and waits for intended device 60 to become accessible for delivery, or software product 10 is delivered to intended device 60 based on the consumer providing access information to that intended device such that system 5 may successfully push product 10 to intended device 60. Delivery mechanisms for distributing data files over communications network 50 include all that would be understood by those skilled in the art.

Video programming 30, as contemplated herein, my be subsidized by a variety of different revenue models, including independent advertisements, such as visual commercials, by product placements, by revenue sharing, or by subscriptions such as through satellite, cable, broadcast or IP providers, or by other independent subscriptions or registrations. For example, in certain embodiments where a consumer has an existing subscription or account with a content provider, such as a cable or satellite TV provider, the consumer may be able to communicate to system 5, such as via an interactive selectable menu viewable on the television display (with video programming 30 continuing to run uninterrupted on at least a portion of the television screen, such as in the upper right quadrant of the display), that he/she would like to purchase the application software product for sale, and the consumer may then be charged through his/her content provider account. The selectable menu may be provided either by the cable or satellite provider, or it may be delivered by system 5 from server 20.

In another exemplary embodiment of the present invention, the system may provide a weekly video program of approximately 30 minutes and hosted by a celebrity, such as a celebrity targeted to the demographic target audience. Application software developers/builders may pay for inclusion in the show and/or placement into an upcoming video program wherein each submitted application is showcased per weekly episode. The video program itself may include sponsors, such as major telecommunications carriers, software developers generally, and/or handheld device developers specifically. The video program may form part of a weekly webisode, or a TV show edited into webisodes, for placement and repurposing, for example. It should be appreciated that such an embodiment may provide the ability to promote cross-platform applications to millions of consumers on at least a weekly basis.

In such embodiments, the consumer may need to enter information suitable for identifying the consumer device 60 for which the application software 10 is intended for delivery. This information may be provided prior to transmission of video programming 30, such as within the memory of a consumer personal account or registration associated with the present system, or within the account information stored at the content provider, or it may be provided, or pinged from a user device, at the point of service, when the consumer attempts to purchase the application software 10. Such identifying information may be a domain or IP address, telephone number, an email or text address, or any other unique identifier for the intended computing device 60 as understood by those skilled in the art. Of course, separate or independent billing may also be set up and provided directly from system 5.

It should also be appreciated that the present invention uniquely provides high quality video programming for the sale of application software to consumers by allowing consumers to view the programming either directly on the device that the application software may be suitable for, or on an independent visual display, where the consumer may separately communicate with the product seller or distributor via a communications network from an interactive device. For example, the video programming may be shown on a gas or fuel station visual display, such as a “pump TV” program, for a consumer to watch while fueling their vehicle. Upon viewing the program content selling the application software, the consumer may access the application software distributor via their phone, or may interact and pay for the application via credit card at the pump payment unit, and/or may have that application, or other content, pushed to their phone.

According to another aspect of the present invention, video programming may include promotional items, such as codes to identify the customer as having viewed the video program, and thereby provide the customer a form of discount or other incentive for purchasing the software product based on viewing the video program. Such a code may be used by the consumer entering the promotional code at the time of purchase, or during any particular interactive feature of the video program.

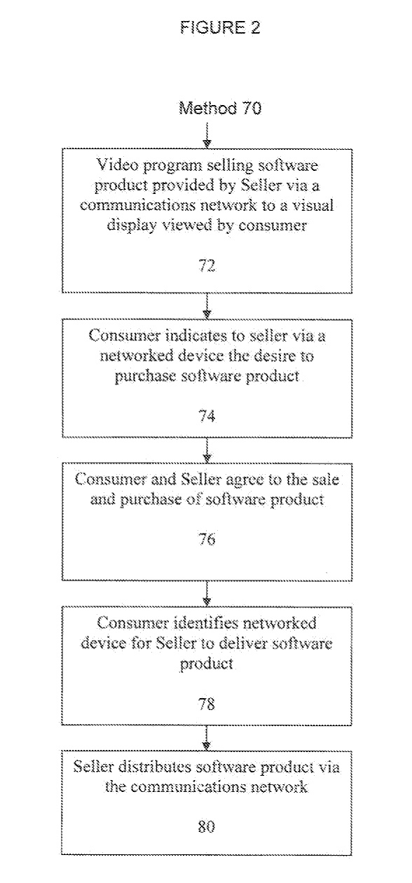

According to another aspect of the present invention, a method of advertising, selling and delivering application software to a prospective consumer is described. For example, as illustrated in FIG. 2, the steps for such a method may be performed as follows. At step 72, The Seller of the application software provides a video program advertising the software product for sale. The video program is transmitted to video displays via a communications network so that the video program may be viewed by prospective consumers. These displays may be any networked display device accessible to a consumer, including displays at a commercial residence, or a personally owned display, such as a consumer's television or computing device. At step 74, the consumer may indicate to the seller via a networked device over the communications network the desire to purchase the advertised software product. This indication may be transmitted directly to the Seller, or it may transmitted indirectly, such as through a cable or satellite TV provider. At step 76, the consumer and seller agree to the sale and purchase of software product. Again, this agreement may be formed directly between consumer and seller, or may be performed indirectly, such as an agreement between consumer and cable or satellite TV provider, and subsequently between cable or satellite TV provider and seller. At step 78, the consumer identifies the intended networked device for the seller to deliver the purchased software product. This identification may be automatic, such as in the event the purchase is made directly from the device for which the purchased software product is intended, or it may be indirect, where the consumer provides a domain name, IP address or other unique identifier of the intended device to the seller for delivery. At step 80, the seller distributes the purchased software product to the consumer's intended device via the communications network.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

1. A system for selling a software product, comprising:
a software product resident within the memory of a computer storage device associated with a server, wherein the server is communicatively connected to a telecommunications network, and wherein the software product is suitable for execution on a first of at least two computing device;
a video program synchronized to one or more aspects of the server, wherein the video program promotes a sale of the software product to a customer viewing the video program;
wherein, the customer purchases the software product via the telecommunications network from one of the at least two devices, and an identification of the first of the computing devices is provided to the server, and wherein the server distributes the purchased software product via the telecommunications network to the first computing device responsive to the identification.

2. The system of claim 1, wherein video program comprises at least one of a salesperson and an endorser.

3. The system of claim 2, wherein the salesperson is a celebrity.

4. The system of claim 2, wherein endorser is a celebrity.

5. The system of claim 2, wherein the salesperson is virtual.

6. The system of claim 2, wherein the endorser is virtual.

7. The system of claim 1, wherein the video program includes a promotion.

8. The system of claim 4, wherein the promotion is a code.

9. The system of claim 1, wherein the customer purchases the software product via the first computing device.

10. The system of claim 1, wherein the customer purchases the software product from a device other than the first computing device.

11. The system of claim 1, wherein the computing device is a handheld computing device.

12. The system of claim 8, wherein the handheld computing device is a phone.

13. The system of claim 1, wherein the video program is at least partially interactive.

14. A method of selling a software product, comprising:
providing, via a communications network, a video program advertising the sale of a software product for display on at least one visual display device, the video program including a salesperson and at least one information item, the information item allowing a consumer viewing the video program on the at least one visual display to communicate with a server via the communications network;
receiving a data transmission indicative of the consumer's desire to purchase the software product;
agreeing to sell the software product to the consumer;
receiving a data transmission indicative of a networked device associated with the consumer for delivery of the purchased software product; and
distributing the software product to the networked device.

15. The method of claim 14, wherein the salesperson is a celebrity.

16. The method of claim 14, wherein the salesperson is virtual.

17. The method of claim 14, wherein the video program includes a promotion.

18. The method of claim 17, wherein the promotion includes a code.

19. The method of claim 14, wherein the video program is at least partially interactive.

20. The method of claim 17, wherein the networked device is a phone.

21. The method of claim 17, wherein receipt of the data transmission indicative of the consumer's desire to purchase the software product passes through a secondary service provider.

22. The method of claim 21, wherein agreement to sell the software product to the consumer is made with the secondary service provider.

23. The method of claim 22, wherein receipt of the data transmission indicative of a networked device for delivery of the purchased software product is provided by the secondary service provider.
